(19) United States
(12) Patent Application Publication
(10) Pub. No.: US 2026/0219473 A1
(43) Pub. Date: Jul. 30, 2026

(54) AUTOFOCUS DRIVING DEVICE, CAMERA DEVICE, AND OPTICAL DEVICE

(71) Applicant: LG INNOTEK CO., LTD., Seoul (KR)

(72) Inventors: Hyeon Jun Jang, Seoul (KR); Tae Hoon KWON, Seoul (KR)

(73) Assignee: LG INNOTEK CO., LTD., Seoul (KR)

(21) Appl. No.: 19/147,637

(22) PCT Filed: Jan. 10, 2024
(86) PCT No.: PCT/KR2024/000511

§ 371 Date: Jul. 11, 2025

(30) Foreign Application Priority Data
Jan. 12, 2023 (KR) 10-2023-0005017

(51) Int. Cl. G02B 7/09; G03B 3/10; G03B 13/36; H02K 33/18; H04N 23/54

(52) U.S. Cl. CPC G02B 7/09; G03B 3/10; G03B 13/36; H02K 33/18; H04N 23/54

(57) ABSTRACT

This embodiment relates to an autofocus driving device comprising: a fixed unit; a movable unit disposed in the fixed unit; a first magnet and a coil for moving the movable unit in the optical axis direction; a ball disposed between the fixed unit and the movable unit; and a second magnet and a yoke having attractive force acting on each other, wherein the first magnet and the coil overlap in a first direction perpendicular to the optical axis direction, and the ball is disposed in the first direction, between the second magnet and the yoke.

### TECHNICAL FIELD

The present embodiment relates to an autofocus driving device, a camera device, and an optical device.

### BACKGROUND ART

A camera device is a device that takes pictures or videos of a subject, and is installed in optical devices such as smartphones, drones, and vehicles.

The camera device is applied with an autofocus function that automatically adjusts the focus according to the distance to the subject. The autofocus function is performed as the lens moves in an optical axis direction with respect to the image sensor and the movement of the lens in the optical axis direction can be guided by a driving magnet and a coil. In addition, the movement of the lens can be guided by a ball. At this time, the attractive force between the driving magnet and the yoke can be used to bring the ball into close contact between the fixed part and the moving part.

However, when a driving magnet is used for ball contact, the yoke must cover the entire range of movement of the driving magnet. Therefore, there is a limit to increasing the height of the driving magnet. If there is a limit to the height of the driving magnet, it can be problematic because it can be difficult to secure linearity during operation.
(Patent Literature 1 KR 10-2015-0118005 A

### DETAILED DESCRIPTION OF THE INVENTION

### Technical Subject

The present embodiment is intended to provide an autofocus driving device with minimal constraints on increasing the height of the driving magnet during design.

The present embodiment is intended to provide an autofocus driving device without any constraints on the height of the driving magnet, since the driving magnet does not play a role in ball contact.

The present embodiment is intended to provide an autofocus driving device with a minimized height in the optical axis direction.

The present embodiment is intended to provide an autofocus driving device in which the driving magnet is designed to have the maximum size in the optical axis direction.

The present embodiment is intended to provide an autofocus driving device with enhanced electromagnetic force between a driving magnet and a coil.

### Technical Solution

An autofocus driving device according to the present embodiment comprises: a fixed unit; a movable unit being disposed in the fixed unit; a first magnet and a coil for moving the movable unit in an optical axis direction; a ball being disposed between the fixed unit and the movable unit; and a second magnet and a yoke having attractive force acting on each other, wherein the first magnet and the coil are overlapped in a first direction perpendicular to the optical axis direction, and wherein the ball may be disposed between the second magnet and the yoke in the first direction.

The ball is overlapped with the second magnet in the first direction, and the ball may be overlapped with the yoke in the first direction.

At least one of the fixed unit and the movable unit comprises a groove in which the ball is disposed, and the groove may be disposed in the optical axis direction.

The yoke may not be overlapped with the first magnet in the first direction.

The second magnet may be spaced apart from the first magnet.

In the optical axis direction, the length of the second magnet may be longer than the length of the first magnet.

In a second direction perpendicular to the optical axis direction and the first direction, the length of the second magnet may be shorter than the length of the first magnet.

The second magnet may be disposed in the fixed unit, and the yoke may be disposed in the movable unit.

The first magnet may be disposed in the movable unit, and the coil may be disposed in the fixed unit.

The autofocus driving device comprises a substrate connecting the movable unit and the fixed unit, the first magnet is disposed in the fixed unit, and the coil is disposed in the movable unit and may be electrically connected to the substrate.

The ball comprises a first ball and a second ball, and when viewed from above, the first ball is disposed at a first corner area of the movable unit, and when viewed from above, the second ball may be disposed at a second corner area diagonal to the first corner area of the movable unit.

The fixed unit comprises a first groove being in contact with the first ball and a second groove being in contact with the second ball, the movable unit comprises a first groove being in contact with the first ball and a second groove being in contact with the second ball, and the second groove of the fixed unit and the second groove of the movable unit may be formed in different shapes.

The second magnet comprises a first unit magnet and a second unit magnet, the yoke comprises a first yoke and a second yoke, the first ball is disposed between the first unit magnet and the first yoke, the second ball is disposed between the second unit magnet and the second yoke, and the first unit magnet may be larger than the second unit magnet.

A camera device according to the present embodiment may comprise a printed circuit board; an image sensor being disposed in the printed circuit board; an autofocus driving device being disposed in the printed circuit board; and a lens being coupled to the autofocus driving device.

An optical device according to the present embodiment may comprise a main body; a camera device being disposed in the main body; and a display being disposed in the main body and outputting at least one or more of an image and a video photographed by the camera device.

### Advantageous Effects

Through the present embodiment, the constraints on increasing the height of the driving magnet during design can be minimized.

Through this, linearity can be secured during AF driving.

In addition, the driving magnet may be disposed to have the maximum size within an autofocus driving device.

Through this, the electromagnetic force between the driving magnet and the coil can be enhanced.

In addition, since the magnets and magnetic elements for a tight ball contact do not have much correlation with other parts, the interior of the autofocus driving device can be designed with a high degree of freedom.

Through this, the height in an optical axis direction of the autofocus driving device can be minimized.

### BRIEF DESCRIPTION OF DRAWINGS

FIG. 1 is a perspective view of a lens driving device according to the present embodiment.

FIG. 2 is a cross-sectional view taken along line A-A of FIG. 1.

FIG. 3 is an exploded perspective view of a lens driving device according to the present embodiment.

FIG. 4 is a perspective view of a lens driving device according to the present embodiment with a cover omitted.

FIG. 5 is a partial perspective view of a lens driving device in a state of FIG. 4 viewed from a different direction from FIG. 4.

FIG. 6 is a plan view of the lens driving device in a state of FIG. 4.

FIG. 7 is an enlarged view of area A of FIG. 6.

FIG. 8 is an enlarged view of area B of FIG. 6.

FIG. 9 is a cross-sectional view taken along line B-B of FIG. 1 and a partial enlarged view thereof.

FIG. 10 is a cross-sectional view taken along line C-C of FIG. 1 and a partial enlarged view thereof.

FIG. 11 is a perspective view illustrating a driving unit and a ball and a ball pressurizing unit of a lens driving device according to the present embodiment.

FIG. 12 is a front view for comparing the sizes of an attractive force magnet and a repulsive magnet of a lens driving device according to the present embodiment.

FIG. 13 is a plan view of a lens driving device according to a first modified embodiment with a cover omitted.

FIG. 14 is an enlarged view of area A of FIG. 13.

FIG. 15 is an enlarged view of area B of FIG. 13.

FIG. 16 is a cross-sectional view of a cross-section cut to illustrate a driving unit of a lens driving device according to a first modified embodiment.

FIG. 17 is a cross-sectional view of a cross-section cut to illustrate a second ball and related components of a lens driving device according to a first modified embodiment.

FIG. 18 is a perspective view illustrating a fixed unit, a substrate, and related components of a lens driving device according to a first modified embodiment.

FIG. 19 is a perspective view of a lens driving device in a state of FIG. 18, viewed from a different direction than FIG. 18.

FIG. 20 is a plan view of a lens driving device according to a second modified embodiment with a cover omitted.

FIG. 21 is a perspective view showing a fixed unit, a substrate, and a related configuration of a lens driving device according to a second modified embodiment.

FIGS. 22 to 24 are drawings for explaining an auto focus driving of a lens driving device according to the present embodiment.

FIG. 22 is a cross-sectional view illustrating a state of the movable unit in an initial state in which no current is applied to a coil.

FIG. 23 is a cross-sectional view illustrating a state in which a movable unit moves upward in an optical axis direction when a forward current is applied to a coil.

FIG. 24 is a cross-sectional view illustrating a state in which a movable unit moves downward in an optical axis direction when a reverse current is applied to a coil.

FIGS. 25 to 27 are drawings for explaining an auto focus driving of a lens driving device according to a first modified embodiment and a second modified embodiment.

FIG. 25 is a cross-sectional view illustrating a state of a movable unit in an initial state in which no current is applied to a coil.

FIG. 26 is a cross-sectional view illustrating a state in which a movable unit moves upward in an optical axis direction when a forward current is applied to a coil.

FIG. 27 is a cross-sectional view illustrating a state in which a movable unit moves downward in an optical axis direction when a reverse current is applied to a coil.

FIG. 28 is an exploded perspective view of a camera device according to the present embodiment.

FIG. 29 is a perspective view of an optical device according to the present embodiment.

FIG. 30 is a perspective view of an optical device according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention. In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used.

These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’ due that another component between that other components.

In addition, when described as being formed or disposed in “on (above)” or “below (under)” of each component, “on (above)” or “below (under)” means that it comprises not only the case where the two components are directly in contact with, but also the case where one or more other components are formed or disposed between the two components. In addition, when expressed as “on (above)” or “below (under)”, the meaning of not only an upward direction but also a downward direction with respect to one component may be comprised

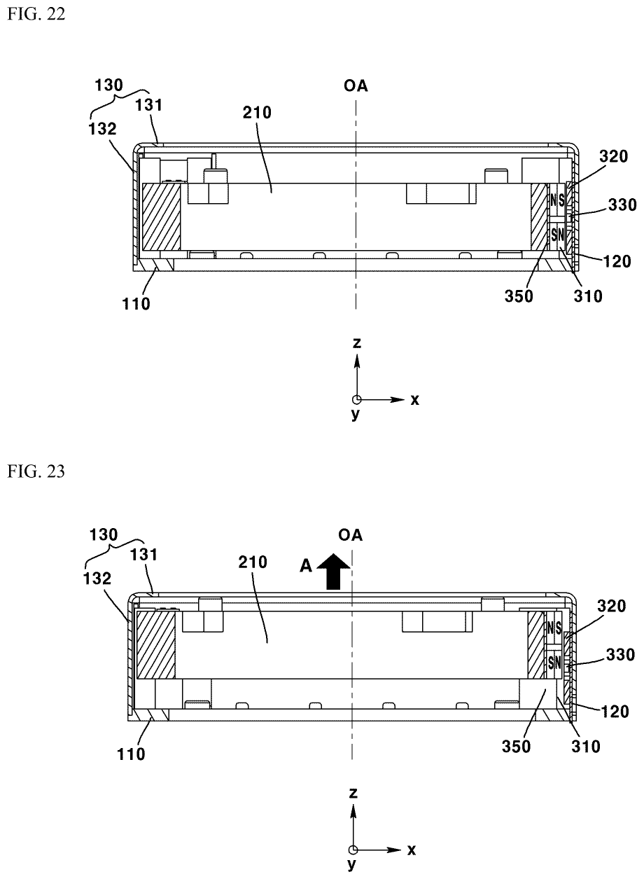

The ‘optical axis (see OA in FIG. 22) direction’ used hereinafter is defined as an optical axis direction of a lens and/or image sensor being coupled to a lens driving device.

The ‘vertical direction’ used hereinafter may be a direction parallel to or the same as an optical axis direction. The vertical direction may correspond to a ‘z-axis direction’. The ‘horizontal direction’ used hereinafter may be a direction perpendicular to a vertical direction. That is, the horizontal direction may be a direction perpendicular to an optical axis. Therefore, a horizontal direction may comprise an ‘x-axis direction’ and a ‘y-axis direction’.

The ‘auto focus (AF) function’ used hereinafter is defined as a function that automatically focuses on a subject by adjusting the distance from an image sensor by moving a lens in an optical axis direction according to the distance to the subject so that a clear image of a subject can be obtained on an image sensor. In addition, ‘closed-loop auto focus (CLAF) control’ is defined as detecting the distance between the image sensor and the lens to provide real-time feedback control of the position of a lens in order to enhance the accuracy of focus adjustment.

Hereinafter, one of an “x-axis” and a “y-axis” is referred to as a “first axis” and the other may be referred to as a “second axis”.

Hereinafter, one of an “x-axis direction” and a “y-axis direction” is referred to as a “first direction” and the other may be referred to as a “second direction”.

Hereinafter, one of a “driving magnet 310” and an “attractive force magnet 510” is referred to as a “first magnet” and the other may be referred to as a “second magnet”.

Hereinafter, a “lens driving device 10” may be an “autofocus driving device”.

Hereinafter, a configuration of a lens driving device according to a present embodiment is described with reference to the drawings.

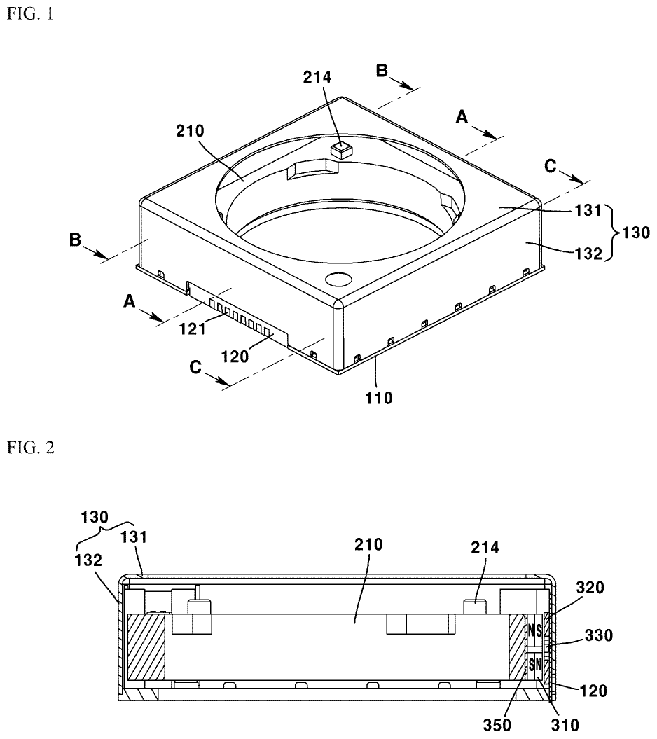

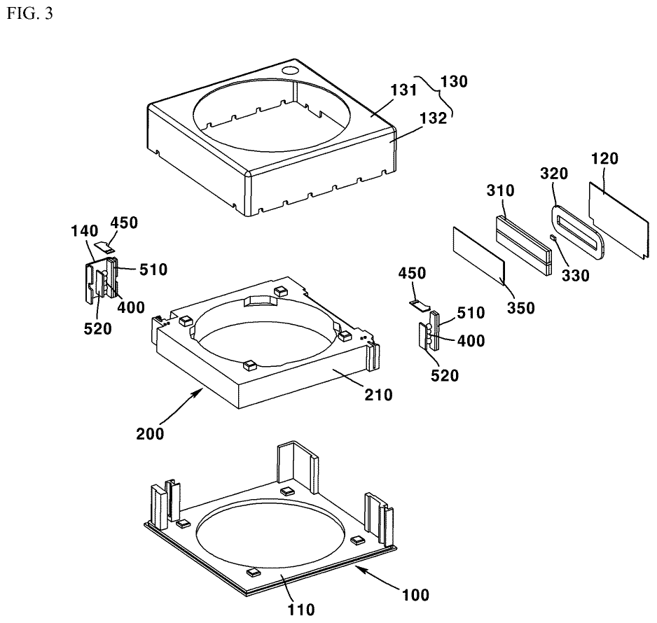

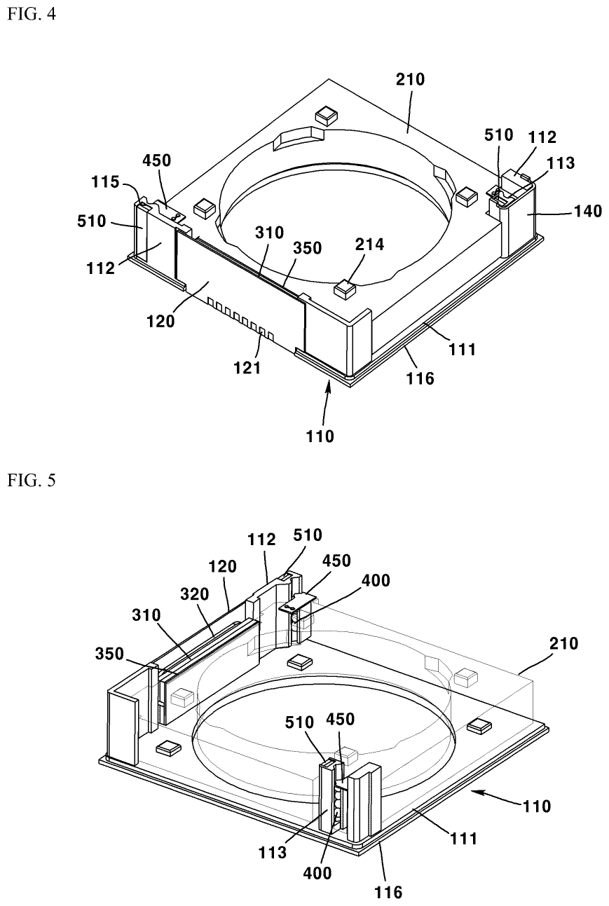

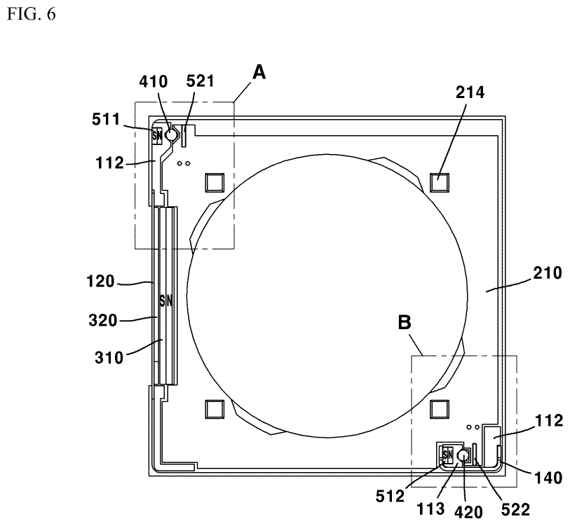

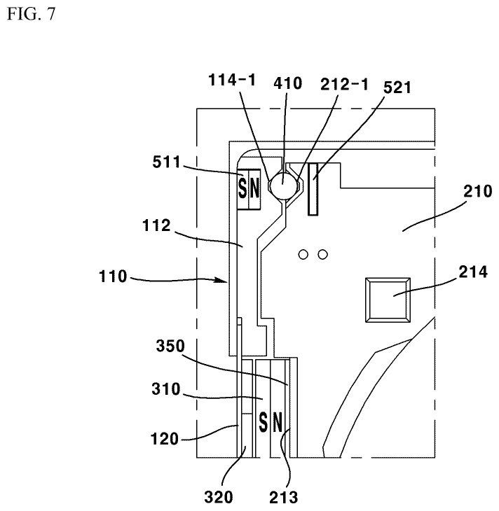

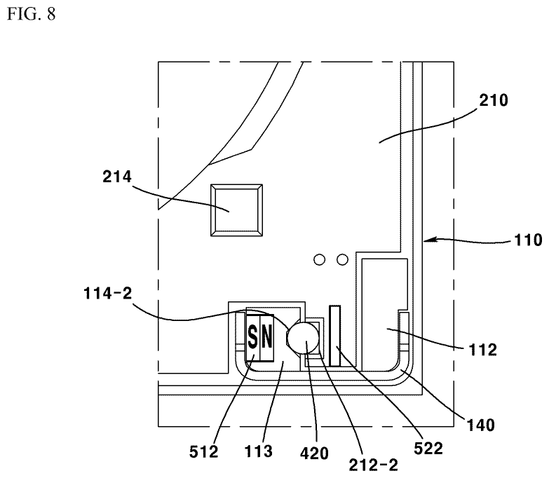

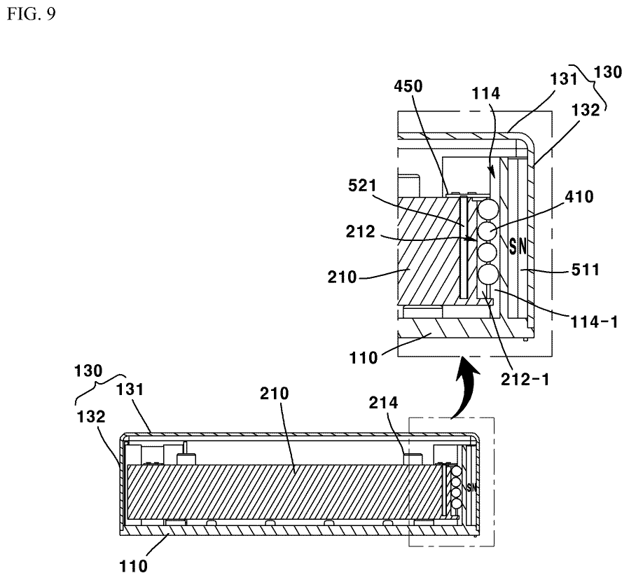

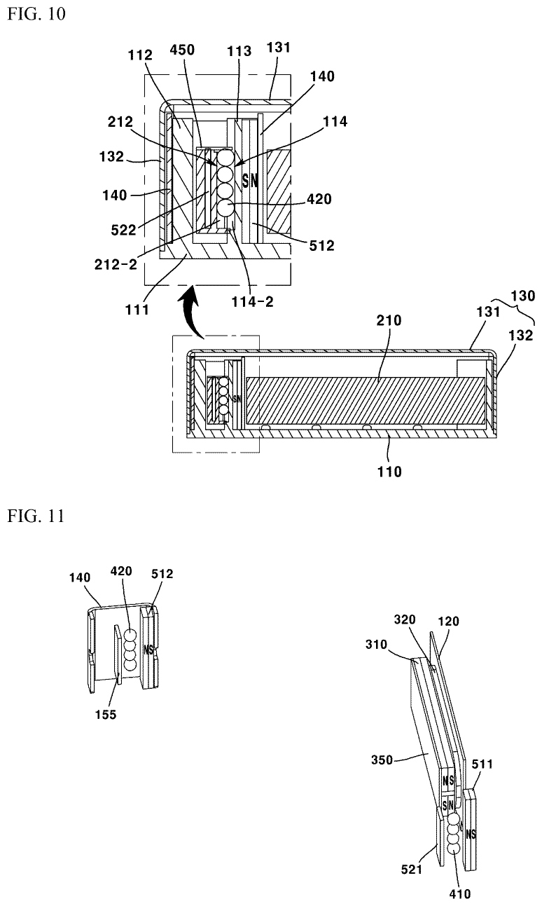

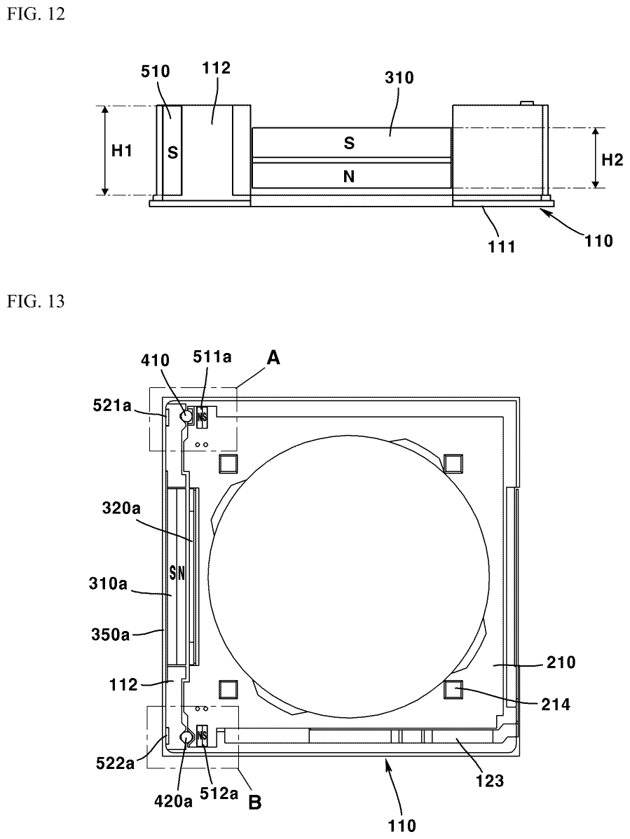

FIG. 1 is a perspective view of a lens driving device according to the present embodiment. FIG. 2 is a cross-sectional view taken along line A-A of FIG. 1. FIG. 3 is an exploded perspective view of a lens driving device according to the present embodiment. FIG. 4 is a perspective view of a lens driving device according to the present embodiment with a cover omitted. FIG. 5 is a partial perspective view of a lens driving device in a state of FIG. 4 viewed from a different direction from FIG. 4. FIG. 6 is a plan view of the lens driving device in a state of FIG. 4. FIG. 7 is an enlarged view of area A of FIG. 6. FIG. 8 is an enlarged view of area B of FIG. 6. FIG. 9 is a cross-sectional view taken along line B-B of FIG. 1 and a partial enlarged view thereof. FIG. 10 is a cross-sectional view taken along line C-C of FIG. 1 and a partial enlarged view thereof. FIG. 11 is a perspective view illustrating a driving unit and a ball and a ball pressurizing unit of a lens driving device according to the present embodiment. FIG. 12 is a front view for comparing the sizes of an attractive force magnet and a repulsive magnet of a lens driving device according to the present embodiment.

The lens driving device 10 may be a voice coil motor (VCM). The lens driving device 10 may be a lens driving motor. The lens driving device 10 may be a lens driving actuator. The lens driving device 10 may comprise an AF module. The lens driving device 10 may comprise an AF actuator.

The lens driving device 10 may comprise a fixed unit 100. The fixed unit 100 may be a relatively fixed part when the movable unit 200 moves. The movable unit 200 may move against the fixed unit 100.

The lens driving device 10 may comprise a base 110. The fixed unit 100 may comprise a base 110. The base 110 may be disposed below the holder 210. The base 110 may be coupled with the cover 130. The holder 210 may be disposed on the base 110. The holder 210 may be disposed on the lower plate 111 of the base 110. The holder 210 may be disposed inside the base 110. The holder 210 may be disposed inside the side plate 112 of the base 110.

The base 110 may comprise a lower plate 111. The lower plate 111 of the base 110 may support a lower surface of the movable unit 200. The lower plate 111 of the base 110 may support a lower surface of the holder 210. The lower plate 111 of the base 110 may function as a lower stopper of the movable unit 200. The lower plate 111 of the base 110 may function as a lower stopper of the holder 210.

The base 110 may comprise a side plate 112. The side plate 112 may be a ‘side portion’. The side plate 112 may be a ‘side wall’. The side plate 112 of the base 110 may extend from an upper surface of the lower plate 111. The side plate 112 may comprise a plurality of side plates.

The base 110 may comprise a pillar portion 113. The pillar portion 113 may be extended from an upper surface of the lower plate 111. A ball 400 may be disposed on the pillar portion 113. A groove 114 in which the ball 400 is disposed may be formed in the pillar portion 113. The pillar portion 113 may be referred to as a ‘protruded portion’

The fixed unit 100 may comprise a first side wall in which a coil 320 is disposed, a second side wall being disposed opposite to the first side wall, and a protruded portion being disposed to be overlapped between a first side wall and a second side wall in a first direction in which the first side wall faces the second side wall. At this time, the protruded portion may be a pillar portion 113. In an x-axis direction, the movable unit 200 may comprise a protruded portion being disposed between a first side wall of the fixed unit 100 and the protruded portion. The ball 400 may be disposed between the protruded portion of the movable unit 200 and the protruded portion of the fixed unit 100.

The base 110 may comprise a groove 114. The pillar portion 113 may comprise a groove 114. The groove 114 may be formed in the pillar portion 113. The groove 114 may be a ‘ball accommodating groove’. A ball 400 may be disposed in the groove 114. The groove 114 may be in direct contact with the ball 400. The groove 114 may be disposed in an optical axis direction.

The groove 114 may comprise a plurality of grooves. The groove 114 may comprise two grooves. The two grooves may be disposed parallel to each other. The groove 114 may comprise a first groove 114-1 and a second groove 114-2. The first groove 114-1 may be in contact with the first ball 410. The second groove 114-2 may be in contact with the second ball 420.

The base 110 may comprise a groove 115. The groove 115 may be an ‘attractive force magnet accommodating groove’. An attractive force magnet 510 may be disposed in the groove 115. The groove 115 may comprise a shape corresponding to the attractive force magnet 510. The groove 115 may be formed on an outer surface of the side plate 112 of the base 110. The depth of the groove 115 may correspond to the thickness of the attractive force magnet 510.

The base 110 may comprise a step 116. The step 116 may be formed at a lower end of an outer side surface of the base 110. The step 116 may be protruded from an outer side surface of the base 110. A side plate 132 of the cover 130 may be disposed in the step 116 of the base 110.

The lens driving device 10 may comprise a substrate 120. The fixed unit 100 may comprise a substrate 120. The substrate 120 may be disposed in the fixed unit 100. The substrate 120 may be disposed in the base 110. The substrate 120 may be disposed in the side plate 112 of the base 110. The substrate 120 may be disposed on an outer surface of the side plate 112 of the base 110. The substrate 120 may be disposed in the cover 130. The substrate 120 may be disposed in the side plate 132 of the cover 130. The substrate 120 may be disposed on an inner surface of the side plate 132 of the cover 130. The substrate 120 may be disposed on an outer surface of the side plate 132 of the cover 130. The substrate 120 may be disposed parallel to the optical axis. A coil 320 and a sensor 330 may be disposed in the substrate 120. The substrate 120 may comprise a printed circuit board. The substrate 120 may comprise a flexible printed circuit board (FPCB.

The substrate 120 may comprise a terminal 121. The terminal 121 may be formed at a lower end of an outer surface of the substrate 120. The terminal 121 of the substrate 120 may be coupled to a printed circuit board 50 of the camera device 10A. The terminal 121 of the substrate 120 may be electrically connected to the printed circuit board 50 of the camera device 10A. The terminal 121 of the substrate 120 may be coupled to the printed circuit board 50 of the camera device 10A by a solder. The terminal 121 may comprise a plurality of terminals. The terminal 121 may comprise eight terminals. The terminal 121 may comprise a terminal being electrically connected to the coil 320. The terminal 121 may comprise a terminal being electrically connected to the sensor 330. The terminal 121 may comprise a grounding terminal for grounding.

The lens driving device 10 may comprise a cover 130. The fixed unit 100 may comprise a cover 130. The cover 130 may be disposed in the base 110. The cover 130 may be disposed in the base 110. The cover 130 may be coupled to the base 110. The cover 130 may be fixed to the base 110. The cover 130 may accommodate a holder 210 therein. The cover 130 may be a shield member. The cover 130 may be a shield can.

The cover 130 may comprise an upper plate 131. The upper plate 131 of the cover 130 may function as an upper stopper of the movable unit 200. The upper plate 131 of the cover 130 may function as an upper stopper of the holder 210. The upper plate 131 may be disposed on the movable unit 200. The upward movement of the movable unit 200 may be limited by the movable unit 200 coming into contact with the upper plate 131. The upper plate 131 may comprise a hole through which light passes.

The cover 130 may comprise a side plate 132. The side plate 132 may be extended from the upper plate 131. The side plate 132 may be disposed in the base 110. The side plate 132 may be disposed in a step 116 being formed to be protruded from a lower portion of an outer side surface of the base 110. The side plate 132 may comprise a plurality of side plates. The side plate 132 may comprise four side plates. The side plate 132 may comprise a first side plate and a second side plate being disposed opposite to each other, and a third side plate and a fourth side plate being disposed opposite to each other.

The lens driving device 10 may comprise a movable unit 200. The movable unit 200 may be disposed in the fixed unit 100. The movable unit 200 may be disposed inside the fixed unit 100. The movable unit 200 may be disposed on the fixed unit 100. The movable unit 200 may be movably disposed in the fixed unit 100. The movable unit 200 may be moved with respect to the fixed unit 100 by the driving unit 300. The movable unit 200 may be moved in an optical axis direction against the fixed unit 100 by the driving unit 300. The movable unit 200 may be movably disposed inside the fixed unit 100 in an optical axis direction. The movable unit 200 may be moved in an optical axis direction. The movable unit 200 can move during AF driving. A lens may be coupled to the movable unit 200.

The lens driving device 10 may comprise a reinforcing plate 140. The fixed unit 100 may comprise the reinforcing plate 140. The reinforcing plate 140 may be disposed to prevent the pillar portion 113 of the base 110 from being damaged. The reinforcing plate 140 may reinforce the pillar portion 113. The reinforcing plate 140 may comprise a shape being bent twice when viewed from above. The reinforcing plate 140 may comprise a first portion being disposed on an outer surface of the side plate 112 of the base 110, a second portion being disposed on an inner surface of the pillar portion 113 of the base 110, and a third portion connecting the first portion and the second portion. The reinforcing plate 140 may comprise a groove for reinforcing bonding with at least one or more of the base 110 and the holder 210. The groove of the reinforcing plate 140 may be formed in the center area.

In the present embodiment, the reinforcing plate 140 may be disposed to surround a ball part being disposed farther away from the driving magnet 310 among the two sets of ball parts. In a modified embodiment, the reinforcing plate 140 may be disposed to surround each of the two sets of ball parts. Or, the reinforcing plate 140 may be disposed to surround a ball part being disposed closer to the driving magnet 310 among the two sets of ball parts.

The lens driving device 10 may comprise a holder 210. The movable unit 200 may comprise a holder 210. The holder 210 may be an ‘AF holder’. The holder 210 may be a ‘bobbin’. The holder 210 may be a ‘carrier’. The holder 210 may be disposed inside the base 110. The holder 210 may be disposed on the base 110. The holder 210 may be disposed inside the cover 130. The holder 210 may be movably disposed. The holder 210 may be movably disposed in an optical axis direction.

The holder 210 may comprise a protruded portion. The protruded portion may be disposed between the side plate 112 of the base 110 and the pillar portion 113. A ball 400 may be disposed in the protruded portion of the holder 210. A groove 212 in which the ball 400 is disposed may be formed in a protruded portion of the holder 210.

The holder 210 may comprise a groove 212. The groove 212 may be a ‘ball accommodating groove’. A ball 400 may be disposed in the groove 212. The groove 212 may be in direct contact with the ball 400. The groove 212 may be disposed in an optical axis direction. The groove 212 may guide the ball 400 to move in an optical axis direction. The groove 212 of the holder 210 may be disposed to face the groove 114 of the base 110. The ball 400 may be disposed between the groove 212 of the holder 210 and the groove 114 of the base 110.

The groove 212 may comprise a plurality of grooves. The groove 212 may comprise two grooves. The two grooves may be disposed parallel to each other. The groove 212 may comprise a first groove 212-1 and a second groove 212-2. The first groove 212-1 may be in contact with the first ball 410. The second groove 212-2 may be in contact with the second ball 420.

The second groove 114-2 of the fixed unit 100 and the second groove 212-2 of the movable unit 200 can be formed in different shapes.

The holder 210 may comprise a groove 213. The groove 213 may be a ‘driving magnet accommodating groove’. The groove 213 may be formed on an outer side surface of the holder 210. The groove 213 may be formed concavely on a side surface of the holder 210. A driving magnet 310 may be disposed in the groove 213. The groove 213 may be formed in a shape corresponding to the driving magnet 310. The groove 213 may be recessed to a depth equal to the thickness of the driving magnet 310.

The holder 210 may comprise an upper stopper 214. The upper stopper 214 may be formed on an upper surface of the holder 210. The upper stopper 214 may be protruded from an upper surface of the holder 210. The upper stopper 214 may comprise a protrusion. The upper stopper 214 may be overlapped with the upper plate 131 of the cover 130 in an optical axis direction. When the holder 210 moves upward in an optical axis direction, the upper stopper 214 may be in contact with the upper plate 131 of the cover 130. The upper stopper 214 may comprise a plurality of upper stoppers. The upper stopper 214 may comprise four upper stoppers.

The lens driving device 10 may comprise a driving unit 300. The driving unit 300 may move the movable unit 200 in an optical axis direction. The driving unit 300 may move the holder 210 in an optical axis direction. The driving unit 300 may move the holder 210 in an optical axis direction through electromagnetic force. The driving unit 300 may comprise a driving magnet 310 and a coil 320. The driving magnet 310 and the coil 320 may move the movable unit 200 in an optical axis direction.

The lens driving device 10 may comprise a driving magnet 310. The driving unit 300 may comprise the driving magnet 310. The driving magnet 310 may be disposed in the movable unit 200. The driving magnet 310 may be disposed in the holder 210. The driving magnet 310 may be fixed to the holder 210. The driving magnet 310 may be coupled to the holder 210. The driving magnet 310 may be attached to the holder 210 by an adhesive. The driving magnet 310 may be disposed inside the cover 130. The driving magnet 310 may be disposed between the coil 320 and the holder 210. The driving magnet 310 may be disposed at an inner side of the coil 320. The driving magnet 310 may be overlapped with the coil 320 in a direction perpendicular to the optical axis. The driving magnet 310 may face the coil 320 in an x-axis direction perpendicular to the optical axis direction. The driving magnet 310 may face the coil 320. The driving magnet 310 may face the coil 320. The driving magnet 310 can be disposed at a position corresponding to the coil 320. The driving magnet 310 may interact with the coil 320. The driving magnet 310 may electromagnetically interact with the coil 320. The driving magnet 310 may move. The driving magnet 310 may be movably disposed. The driving magnet 310 may move during AF driving. The driving magnet 310 may move together with the holder 210. The driving magnet 310 can move in an optical axis direction. When a current is applied to the coil 320, the driving magnet 310 may move in an optical axis direction.

The driving magnet 310 may be a four-pole magnet. The driving magnet 310 may comprise a four-pole magnetizing magnet. The driving magnet 310 may comprise a lower magnet portion comprising an N pole and an S pole. The driving magnet 310 may comprise an upper magnet portion comprising an S pole and an N pole. The driving magnet 310 may comprise a neutral portion being disposed between a lower magnet portion and an upper magnet portion.

An upper magnet portion may be disposed on a lower magnet portion. The lower magnet portion and the upper magnet portion may be disposed in an optical axis direction. The lower magnet portion and the upper magnet portion may be spaced apart in an optical axis direction. A neutral portion may be disposed between the lower magnet portion and the upper magnet portion.

The lens driving device 10 may comprise a coil 320. The driving unit 300 may comprise a coil 320. The coil 320 may be disposed in the substrate 120. The coil 320 may be disposed on an inner surface of the substrate 120. The coil 320 may be disposed in the fixed unit 100. The coil 320 may be disposed in the base 110. The coil 320 may be disposed in the cover 130. The coil 320 may be disposed at an outer side of the driving magnet 310. The coil 320 may be disposed between the side plate 132 of the cover 130 and the driving magnet 310. The coil 320 may be fixed. The coil 320 may be maintained in a fixed state even during AF driving. The coil 320 can interact with the driving magnet 310. The coil 320 can face the driving magnet 310. The coil 320 can face the driving magnet 310. The coil 320 can be disposed at a position corresponding to the driving magnet 310. The coil 320 may be overlapped with the driving magnet 310 in a direction perpendicular to the optical axis. The coil 320 may be overlapped with the driving magnet 310 in an x-axis direction perpendicular to the optical axis direction.

The lens driving device 10 may comprise a sensor 330. The driving unit 300 may comprise a sensor 330. The sensor 330 may detect a driving magnet 310. The sensor 330 may be disposed in the substrate 120. The sensor 330 may be disposed in the coil 320. The sensor 330 may be a Hall sensor. The amount of movement or position of the driving magnet 310 detected by the sensor 330 may be used for feedback of auto focus driving.

In a modified embodiment, the sensor 330 may be a driver IC. The driver IC may comprise a Hall element that detects the driving magnet 310. The driver IC may comprise a sensing unit. The sensing unit may comprise a Hall element (Hall IC). The driver IC may be electrically connected to the coil 320. The driver IC may apply a current to the coil 320.

The lens driving device 10 may comprise a yoke 350. The driving unit 300 may comprise the yoke 350. The yoke 350 may be disposed in the driving magnet 310. The yoke 350 may be disposed in the holder 210. The yoke 350 may be disposed in the movable unit 200. The yoke 350 may be disposed on an inner surface of the driving magnet 310. The leakage of magnetic flux of the driving magnet 310 may be prevented by the yoke 350. That is, as the yoke 350 is disposed, the electromagnetic interaction force between the driving magnet 310 and the coil 320 may be enhanced.

The lens driving device 10 may comprise a guide member. The guide member may be a guide portion. The guide member may comprise a ball 400. The guide member may comprise a shaft. The guide member may comprise a pin. The guide member may comprise a cylindrical member. The guide member may guide the movement of the movable unit 200 against the fixed unit 100 in a specific direction.

The lens driving device 10 may comprise a ball 400. The ball 400 may guide the movement of the movable unit 200 against the fixed unit 100 in an optical axis direction. The ball 400 may guide the movement of the holder 210 against the base 110 in an optical axis direction. The ball 400 may be disposed between the fixed unit 100 and the movable unit 200. The ball 400 may be disposed between the base 110 and the holder 210. The ball 400 may be disposed between the base 110 and the holder 210 in an x direction. Or, the ball 400 may be disposed between the base 110 and the holder 210 in a y direction. The ball 400 may be disposed in the groove 114 of the base 110. The ball 400 may be disposed in the groove 212 of the holder 210. The ball 400 may be disposed in the groove 114 of the base 110 and the groove 212 of the holder 210. The ball 400 can be disposed between the groove 114 of the base 110 and the groove 212 of the holder 210. The ball 400 may be in the shape of a sphere. The ball 400 may be formed of metal. The ball 400 may be formed non-magnetically. Grease may be applied to a surface of the ball 400.

When viewed from above, the side plate 112 of the base 110, the protruded portion of the holder 210, the ball 400, and the pillar portion 113 of the base 110 can be disposed in sequence on a virtual straight line.

The driving magnet 310 and the coil 320 may be overlapped in an x-axis direction. The ball 400 may be disposed between the attractive force magnet 510 and the yoke 520 in an x-axis direction. The ball 400 may be overlapped with the attractive force magnet 510 in an x-axis direction. The ball 400 may be overlapped with the yoke 520 in an x-axis direction.

At least one of the fixed unit 100 and the movable unit 200 may comprise grooves 114 and 212 in which a ball 400 is disposed. The grooves 114 and 212 may be disposed in an optical axis direction. Through this, the ball 400 may move in an optical axis direction. Accordingly, the movable unit 200 may be guided by the ball 400 and may move in an optical axis direction against the fixed unit 100.

The ball 400 may comprise a plurality of balls. The ball 400 may comprise a plurality of unit balls. The balls 400 may be provided in two sets of four balls each, with a total of eight balls. The ball 400 may comprise a first ball 410 and a second ball 420. The first ball 410 may be disposed in a first corner area of the optical axis, the base 110, and the holder 210. The second ball 420 may be disposed in a second corner area of the optical axis, the base 110, and the holder 210. At this time, the first corner and the second corner may be disposed diagonally from each other. When viewed from above, the first ball 410 may be disposed in the first corner area of the movable unit 200. When viewed from above, the second ball 420 may be disposed in the second corner area at a diagonal direction of the first corner area of the movable unit 200.

The first ball 410 may be disposed in the first groove 114-1 of the fixed unit 100. The first ball 410 may come into contact with the first groove 114-1 of the fixed unit 100. The first ball 410 may be guided by the first groove 114-1 of the fixed unit 100. The first ball 410 may move along the first groove 114-1 of the fixed unit 100. The first ball 410 may be disposed in the first groove 212-1 of the movable unit 200. The first ball 410 may come into contact with the first groove 212-1 of the movable unit 200. The first ball 410 may be guided by the first groove 212-1 of the movable unit 200. The first ball 410 may move along the first groove 212-1 of the movable unit 200. The first ball 410 may be disposed between the first groove 114-1 of the fixed unit 100 and the first groove 212-1 of the movable unit 200.

The first groove 114-1 of the fixed unit 100 may be a groove in the shaped of a letter V when viewed from above. The first groove 114-1 may be in contact with the first ball 410 at two points. The first groove 114-1 may be a two-point contact groove. The first groove 212-1 of the movable unit 200 may be a groove in the shaped of a letter V when viewed from above. The first groove 212-1 may be in contact with the first ball 410 at two points. The first groove 212-1 may be a two-point contact groove.

The first ball 410 may be disposed between the first unit magnet 511 and the first yoke 521. The first ball 410 may be disposed between the first unit magnet 511 and the first yoke 521 in an x-axis direction. The first ball 410 may be overlapped with the first unit magnet 511 in an x-axis direction. The first ball 410 may be overlapped with the first yoke 521 in an x-axis direction.

The second ball 420 may be disposed in the second groove 114-2 of the fixed unit 100. The second ball 420 may come into contact with the second groove 114-2 of the fixed unit 100. The second ball 420 may be guided by the second groove 114-2 of the fixed unit 100. The second ball 420 may move along the second groove 114-2 of the fixed unit 100. The second ball 420 may be disposed in the second groove 212-2 of the movable unit 200. The second ball 420 may come into contact with the second groove 212-2 of the movable unit 200. The second ball 420 may be guided by the second groove 212-2 of the movable unit 200. The second ball 420 may move along the second groove 212-2 of the movable unit 200. The second ball 420 may be disposed between the second groove 114-2 of the fixed unit 100 and the second groove 212-2 of the movable unit 200.

The second groove 114-2 of the fixed unit 100 may be a groove in the shape of a letter V when viewed from above. The second groove 114-2 may be in contact with the second ball 420 at two points. The second groove 114-2 may be a two-point contact groove. The second groove 212-2 of the movable unit 200 may be a groove in the shape of a letter U or C when viewed from above. The second groove 212-2 may be in contact with the second ball 420 at one point. Or, the second groove 212-2 may be in contact with the second ball 420 at two points. Or, the second groove 212-2 may be in contact with the second ball 420 at three points.

The second ball 420 may be disposed between the second unit magnet 512 and the second yoke 522. The second ball 420 may be disposed between the second unit magnet 512 and the second yoke 522 in an x-axis direction. The second ball 420 may be overlapped with the second unit magnet 512 in an x-axis direction. The second ball 420 may be overlapped with the second yoke 522 in an x-axis direction.

The lens driving device 10 may comprise a cover 450. The cover 450 may be a ‘ball cover’. The cover 450 may be disposed in the holder 210. The cover 450 may be coupled to the holder 210. The cover 450 may be fixed to the holder 210. The cover 450 may be disposed on an upper surface of the holder 210. The cover 450 may comprise a hole being coupled with a protrusion of the holder 210. The cover 450 may be overlapped with the ball 400 in an optical axis direction. The cover 450 may cover an upper side of the ball 400. The cover 450 may cover the ball 400 from above. The cover 450 may prevent the ball 400 from being detached upward.

The lens driving device 10 may comprise a ball pressurizing member. The ball pressurizing member may pressurize the ball 400. The ball pressurizing member may pressurize the ball 400 between the fixed unit 100 and the movable unit 200. The ball pressurizing member may pressurize the ball 400 against the fixed unit 100 and the movable unit 200. The ball pressurizing member may maintain the ball 400 in contact with the fixed unit 100 and the movable unit 200. The ball pressurizing member may comprise an attractive force magnet 510 and a yoke 520 on which an attractive force is applied to each other.

The lens driving device 10 may comprise an attractive force magnet 510. The ball pressurizing member may comprise an attractive force magnet 510. The attractive force magnet 510 may be disposed in the fixed unit 100. The attractive force magnet 510 may be coupled to the fixed unit 100. The attractive force magnet 510 may be fixed to the fixed unit 100. The attractive force magnet 510 may be attached to the fixed unit 100 with an adhesive. The attractive force magnet 510 may be disposed in the base 110. The attractive force magnet 510 may be coupled to the base 110. The attractive force magnet 510 may be fixed to the base 110. The attractive force magnet 510 may be attached to the base 110 with an adhesive. The attractive force magnet 510 may be disposed on an outer surface of the base 110. The attractive force magnet 510 may be disposed in the groove 115 of the base 110. The attractive force magnet 510 may be disposed in the cover 130. The attractive force magnet 510 may be disposed in the side plate 132 of the cover 130. The attractive force magnet 510 may be disposed on an inner surface of the side plate 132 of the cover 130.

An attractive force magnet 510 may exert an attractive force on the yoke 520. The attractive force magnet 510 may be disposed so that an attractive force acts on the yoke 520. The attractive force magnet 510 may be disposed at a position corresponding to the yoke 520. The attractive force magnet 510 may be disposed to be adjacent to the yoke 520. The attractive force magnet 510 may pressurize the yoke 520 toward the ball 400. The attractive force magnet 510 may pull the yoke 520 toward the ball 400. The attractive force magnet 510 may pressurize the holder 210 toward the ball 400 through an attractive force with the yoke 520. The ball 400 may be in close contact between the fixed unit 100 and the movable unit 200 by an attractive force between the attractive force magnet 510 and the yoke 520. The ball 400 may be in close contact between the base 110 and the holder 210 by an attractive force between the inert force magnet 510 and the yoke 520.

The attractive force magnet 510 may be overlapped with the yoke 520 in an x-axis direction. The attractive force magnet 510 may be overlapped with the ball 400 in an x-axis direction. The attractive force magnet 510 may be disposed between the side plate 132 of the cover 130 and the base 110 in an x-axis direction.

The attractive force magnet 510 may be spaced apart from the driving magnet 310. The attractive force magnet 510 may be formed as a separate member from the driving magnet 310. Through this, the design freedom of the driving magnet 310 may be secured. The attractive force magnet 510 may not be overlapped with the driving magnet 310 in an optical axis direction. The attractive force magnet 510 may not be overlapped with the driving magnet 310 in an x-axis direction. The attractive force magnet 510 may not be overlapped with the driving magnet 310 in a y-axis direction.

Referring to FIG. 12, in an optical axis direction, the length H1 of the attractive force magnet 510 may be longer than the length H2 of the driving magnet 310. In the optical axis direction, the length H2 of the driving magnet 310 may be 60 to 74% of the length H1 of the attractive force magnet 510. In an optical axis direction, the length H2 of the driving magnet 310 may be 55 to 79% of the length H1 of the attractive force magnet 510. Since the length of the attractive force magnet 510 is formed longer than the length of the driving magnet 310, even when the driving magnet 310 moves up and down, the attractive force of the attractive force magnet 510 may be maintained throughout the entire section.

In a y-axis direction, the length of the attractive force magnet 510 may be shorter than the length of the driving magnet 310. In an x-axis direction, the length of the attractive force magnet 510 may be shorter than the length of the driving magnet 310. In an x-axis direction, the length of the attractive force magnet 510 may be equal to the length of the driving magnet 310. In an x-axis direction, the length of the attractive force magnet 510 may be longer than the length of the driving magnet 310.

In an optical axis direction, the length of the yoke 520 may be shorter than the length of the driving magnet 310. The length of the yoke 520 may be 91 to 97% of the length of the driving magnet 310. The length of the yoke 520 may be 90 to 98% of the length of the driving magnet 310. In a modified embodiment, the length of the yoke 520 may be equal to the length of the driving magnet 310. In a modified embodiment, the length of the yoke 520 may be longer than the length of the driving magnet 310.

The length of the attractive force magnet 510 in an optical axis direction may be formed to be overlapped with the yoke 520 over the entire movement range of the yoke 520. That is, when the yoke 520 is moved upward to the maximum, the upper end of the attractive force magnet 510 and the upper end of the yoke 520 may be disposed at corresponding heights. In addition, when the yoke 520 is moved downward to the maximum, the lower end of the attractive force magnet 510 and the lower end of the yoke 520 may be disposed at corresponding heights. At an initial position, the upper end of the attractive force magnet 510 may be disposed higher than the upper end of the yoke 520. At an initial position, the lower end of the attractive force magnet 510 may be disposed lower than the lower end of the yoke 520. At an initial position, the upper end of the attractive force magnet 510 may be disposed higher than the upper end of the driving magnet 310. At an initial position, the lower end of the attractive force magnet 510 may be disposed lower than the lower end of the driving magnet 310.

The attractive force magnet 510 may be a two-pole magnet. The attractive force magnet 510 may be formed with inner and outer surfaces having different polarities. In a modified embodiment, the attractive force magnet 510 may be a four-pole magnet.

The attractive force magnet 510 may comprise a plurality of magnets. The attractive force magnet 510 may comprise two magnets. The attractive force magnet 510 may comprise a first unit magnet 511 and a second unit magnet 512. The first unit magnet 511 and the second unit magnet 512 may be spaced apart from each other. The first unit magnet 511 may pressurize the first ball 410. The second unit magnet 512 may pressurize the second ball 420.

The lens driving device 10 may comprise a yoke 520. The ball pressurizing member may comprise a yoke 520. The yoke 520 may be disposed in the movable unit 200. The yoke 520 may be coupled to the movable unit 200. The yoke 520 may be fixed to the movable unit 200. The yoke 520 may be attached to the movable unit 200 with an adhesive. The yoke 520 may be disposed in the holder 210. The yoke 520 may be coupled to the holder 210. The yoke 520 may be fixed to the holder 210. The yoke 520 may be attached to the holder 210 with an adhesive.

The yoke 520 may be a magnetic yoke. The yoke 520 can exert an attractive force with the attractive force magnet 510. The yoke 520 may be positioned at a position corresponding to the attractive force magnet 510. The yoke 520 may face the attractive force magnet 510. The yoke 520 may be positioned at an opposite side of the attractive force magnet 510 with respect to the ball 400. The yoke 520 may pressurize the ball 400. The yoke 520 may cause the movable unit 200 to pressurize the ball 400 toward the fixed unit 100. The yoke 520 may cause the holder 210 to pressurize the ball 400 toward the base 110.

The yoke 520 may not be overlapped with the driving magnet 310 in an x-axis direction. The yoke 520 may not be overlapped with the coil 320 in an x-axis direction. The yoke 520 may be overlapped with the attractive force magnet 510 in an x-axis direction. The yoke 520 may be overlapped with the ball 400 in an x-axis direction.

The yoke 520 may comprise a plurality of yokes. The yoke 520 may comprise two yokes. The yoke 520 may comprise a first yoke 521 and a second yoke 522. The first yoke 521 and the second yoke 522 may be spaced apart from each other. The first yoke 521 may be disposed at a position corresponding to the first unit magnet 511. The first yoke 521 may exert an attractive force with the first unit magnet 511. The second yoke 522 may be disposed at a position corresponding to the second unit magnet 512. The second yoke 522 may exert an attractive force with the second unit magnet 512

Hereinafter, a configuration of a lens driving device according to a first modified embodiment is described with reference to the drawings.

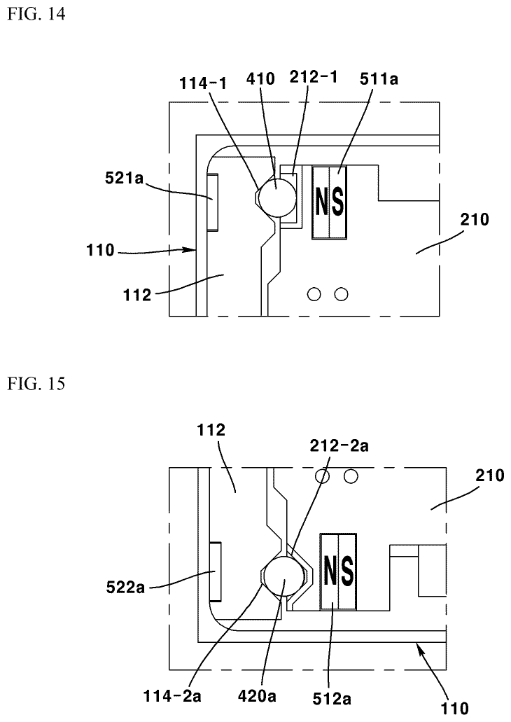

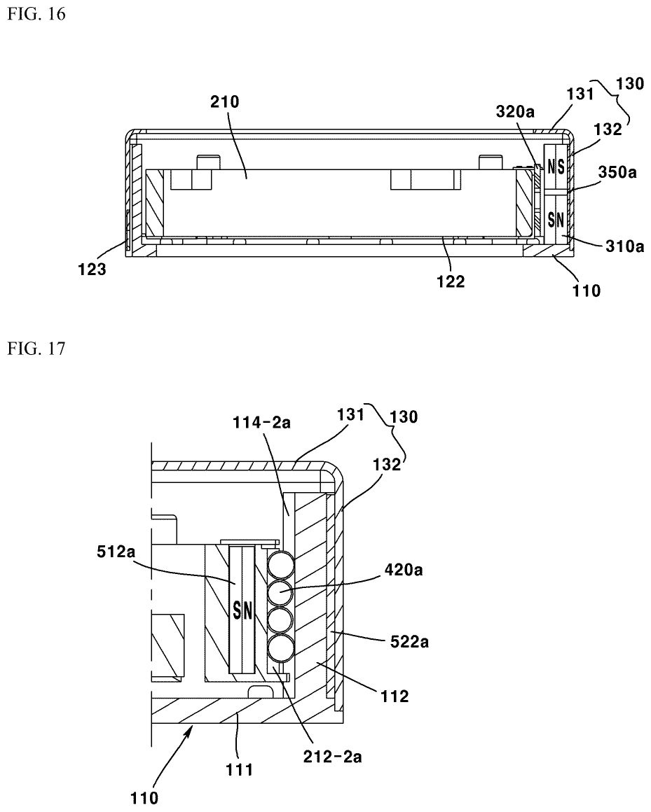

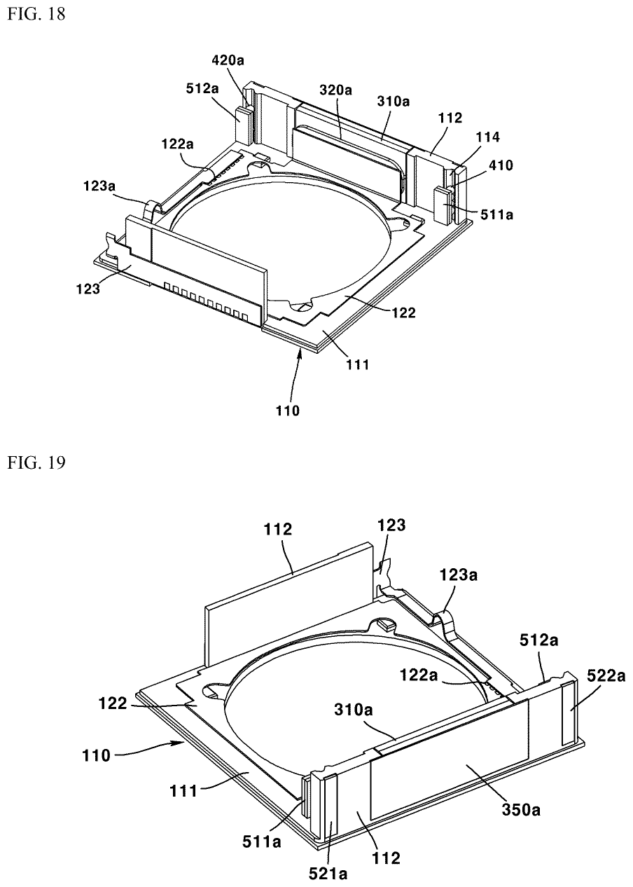

FIG. 13 is a plan view of a lens driving device according to a first modified embodiment with a cover omitted. FIG. 14 is an enlarged view of area A of FIG. 13. FIG. 15 is an enlarged view of area B of FIG. 13. FIG. 16 is a cross-sectional view of a cross-section cut to illustrate a driving unit of a lens driving device according to a first modified embodiment. FIG. 17 is a cross-sectional view of a cross-section cut to illustrate a second ball and related components of a lens driving device according to a first modified embodiment. FIG. 18 is a perspective view illustrating a fixed unit, a substrate, and related components of a lens driving device according to a first modified embodiment. FIG. 19 is a perspective view of a lens driving device in a state of FIG. 18, viewed from a different direction than FIG. 18.

Hereinafter, the lens driving device according to the first modified embodiment will be described with a focus on the differences from the lens driving device according to the present embodiment. Therefore, the configuration according to a first modified embodiment that is not described below may be applied analogically to the description in the present embodiment.

A lens driving device according to the first modified embodiment may comprise substrates 122 and 123 connecting a movable unit 200 and a fixed unit 100. The substrate may comprise an inner substrate 122. The substrate may comprise an outer substrate 123. A driving magnet 310 may be disposed in the fixed unit 100. A coil 320 may be disposed in the movable unit 200. The coil 320 may be electrically connected to the substrates 122 and 123.

The inner substrate 122 may comprise a terminal 122a. The terminal 122a of the inner substrate 122 may be disposed on an upper surface of the inner substrate 122. The terminal 122a of the inner substrate 122 may be coupled to the outer substrate 123. The terminal 122a of the inner substrate 122 may be electrically connected to the terminal of the outer substrate 123.

The outer substrate 123 may comprise a connecting portion 123a. The connecting portion 123a may comprise a bent portion. The connecting portion 123a may comprise a bent shape. The connecting portion 123a may comprise a bent shape. The connecting portion 123a may be movably formed. The outer substrate 123 may comprise a fixed unit being fixed to the base 110. The connecting portion 123a may connect the fixed unit of the outer substrate 123 and the inner substrate 122. The connecting portion 123a of the outer substrate 123 may movably support the holder 210. The connecting portion 123a of the outer substrate 123 may be electrically connected to a coil 320a disposed in the movable unit 200.

In a first modified embodiment, the second ball 420a may be disposed at a different position than in the present embodiment. In the present embodiment, the second ball 420 may be disposed at the second corner area of the movable unit 200. In a first modified embodiment, the second ball 420a may be disposed at the third corner area. When viewed from above, the second corner area is in the 5 o'clock direction, and the third corner area may be in the 7 o'clock direction.

Accordingly, the second groove 114-2a of the fixed unit 100 and the second groove 212-2a of the movable unit 200 may also be disposed in the third corner areas of the fixed unit 100 and the movable unit 200. The second ball 420a may be disposed between the second groove 114-2a of the fixed unit 100 and the second groove 212-2a of the movable unit 200.

In a first modified embodiment, the driving magnet 310a may be disposed in the fixed unit 100. The coil 320a may be disposed in the movable unit 200. When a current is applied to the coils 320 and 320a, in the present embodiment, the driving magnet 310 moves, but in a first modified embodiment, the coil 320a may move. The coil 320a may be disposed in the inner substrate 122. The coil 320a may be electrically connected to the inner substrate 122 and the outer substrate 123. The coil 320a may be movably supported through the outer substrate 123.

In a first modified embodiment, the yoke 350a may be disposed on an outer surface of the driving magnet 310a. Through this, the yoke 350a may enhance the electromagnetic interaction force between the driving magnet 310a and the coil 320a.

In a first modified embodiment, the attractive force magnets 511a and 512a may be disposed in the movable unit 200. The first unit magnet 511a and the second unit magnet 512a may be disposed in the movable unit 200. At this time, the yokes 521a and 522a may be disposed in the fixed unit 100. The first yoke 521a and the second yoke 522a may be disposed in the fixed unit 100.

In a first modified embodiment, the first groove 114-1 of the fixed unit 100 may be a groove in the shape of letter V when viewed from above. The first groove 114-1 may be in contact with the first ball 410 at two points. The first groove 114-1 may be a two-point contact groove. The first groove 212-1 of the movable unit 200 may be a groove in the shape of a letter U or C when viewed from above. The first groove 212-1 may be in contact with the first ball 410 at one point. Or, the first groove 212-1 may be in contact with the first ball 410 at two points. Or the first groove 212-1 may be in contact with the first ball 410 at three points.

In a first modified embodiment, the second groove 114-2a of the fixed unit 100 may be a groove in the shape of a letter V when viewed from above. The second groove 114-2a may contact the second ball 420a at two points. The second groove 114-2a may be a two-point contact groove. The second groove 212-2a of the movable unit 200 may be a groove in the shape of a letter V when viewed from above. The second groove 212-2a may contact the second ball 420a at two points. The second groove 212-2a may be a two-point contact groove.

Hereinafter, a configuration of a lens driving device according to a second modified embodiment is described with reference to the drawings.

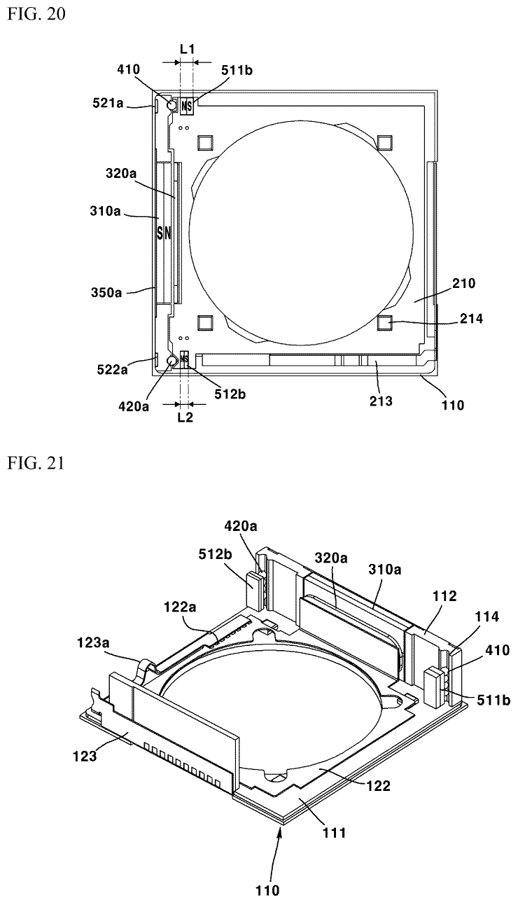

FIG. 20 is a plan view of a lens driving device according to a second modified embodiment with a cover omitted. FIG. 21 is a perspective view showing a fixed unit, a substrate, and a related configuration of a lens driving device according to a second modified embodiment.

Hereinafter, a lens driving device according to a second modified embodiment will be described mainly with respect to the differences between the lens driving devices according to the present embodiment and a first modified embodiment. Therefore, the configuration according to the second modified embodiment that is not described below can be analogically applied based on the descriptions in the present embodiment and the first modified embodiment.

In a lens driving device according to a second modified embodiment, the first unit magnet 511b may be larger than the second unit magnet 512b. Referring to FIG. 20, in an x-axis direction, the thickness of the first unit magnet 511b may be larger than the thickness of the second unit magnet 512b. Through this, the attractive force between the first unit magnet 511b and the first yoke 521b may be larger than the attractive force between the second unit magnet 512b and the second yoke 522b.

Hereinafter, the deformable configurations of a lens driving device according to the present embodiment, a first modified embodiment, and a second modified embodiment will be described again. The attractive force magnet 510 is disposed in the fixed unit 100 and the yoke 520 may be disposed in the movable unit 200. Or, the attractive force magnet 510 is disposed in the movable unit 200 and the yoke 520 may be disposed in the fixed unit 100. The driving magnet 310 is disposed in the movable unit 200 and the coil 320 may be disposed in the fixed unit 100. Or, the driving magnet 310 is disposed in the fixed unit 100 and the coil 320 may be disposed in the movable unit 200. The first ball 410 is disposed in the first corner area, and the second ball 420 may be disposed in the second corner area at a diagonal direction of the first corner area. Or, the second ball 420 may be disposed in the third corner area not at a diagonal direction of the first corner area. At this time, the driving magnet 310 may be disposed between the first corner area and the third corner area. The sizes of the first unit magnet 511 and the second unit magnet 512 may be the same. Or, the sizes of the first unit magnet 511 and the second unit magnet 512 may be different.

In the present embodiment, the attractive force magnet 510 may be disposed in the fixed unit 100. In the case of a modified embodiment, the attractive force magnet 510 is disposed in the movable unit 200. In this case, the present embodiment may be advantageous because the movement of the movable unit 200 may be caused by other magnetic components. Meanwhile, in the present embodiment, the coil 320 may be disposed in the fixed unit 100. In the case of a modified embodiment, the coil 320 is disposed in the movable unit 200. In this case, there is a disadvantage in that the design of the substrate for supplying current to the coil 320 becomes complicated. In the present embodiment, the first ball 410 and the second ball 420 may be disposed diagonally to each other. At this time, the phenomenon of tilt occurring in the movable unit 200 can be minimized.

Hereinafter, the auto focus (AF) driving of the lens driving device according to the present embodiment is described with reference to the drawings.

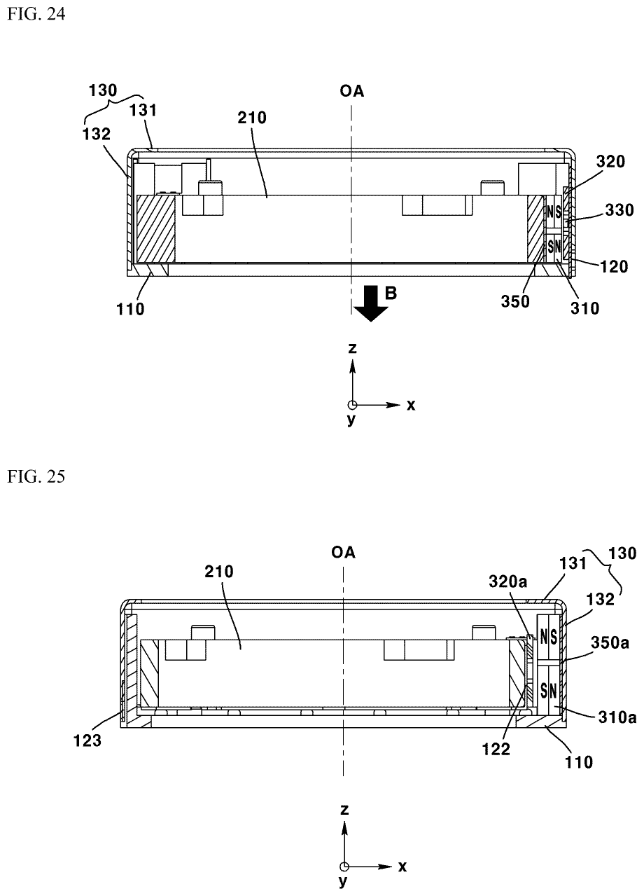

FIGS. 22 to 24 are drawings for explaining an auto focus driving of a lens driving device according to the present embodiment. FIG. 22 is a cross-sectional view illustrating a state of the movable unit in an initial state in which no current is applied to a coil. FIG. 23 is a cross-sectional view illustrating a state in which a movable unit moves upward in an optical axis direction when a forward current is applied to a coil. FIG. 24 is a cross-sectional view illustrating a state in which a movable unit moves downward in an optical axis direction when a reverse current is applied to a coil.

As illustrated in FIG. 22, the movable unit 200 may be disposed at a position spaced apart from both the upper plate 131 of the cover 130 and the base 110 in an initial position where no current is applied to the coil 320.

When a forward current is applied to the coil 320, the driving magnet 310 may move upward in an optical axis direction due to the electromagnetic interaction between the coil 320 and the driving magnet 310 (see A of FIG. 23). At this time, the holder 210 may move upward in an optical axis direction together with the driving magnet 310. Furthermore, a lens may move upward in an optical axis direction together with the holder 210. Accordingly, the distance between the lens and the image sensor is changed, and the focus of the image being formed on the image sensor through the lens may be adjusted.

When a reverse current is applied to the coil 320, the driving magnet 310 may move downward in an optical axis direction due to the electromagnetic interaction between the coil 320 and the driving magnet 310 (see B of FIG. 24). At this time, the holder 210 may move downward in an optical axis direction together with the driving magnet 310. Furthermore, the lens may move downward in an optical axis direction together with the holder 210. Accordingly, the distance between the lens and the image sensor may be changed, and the focus of the image being formed on the image sensor through the lens may be adjusted.

Meanwhile, during the movement process of the driving magnet 310, the sensor 330 may detect the strength of the magnetic field of the driving magnet 310 to detect the amount of movement or position of the lens in an optical axis direction. The amount of movement or position of the lens in an optical axis direction detected by the sensor 330 may be used for auto focus feedback control.

Hereinafter, the auto focus (AF) driving of the lens driving device according to a first modified embodiment and a second modified embodiment is described with reference to the drawings.

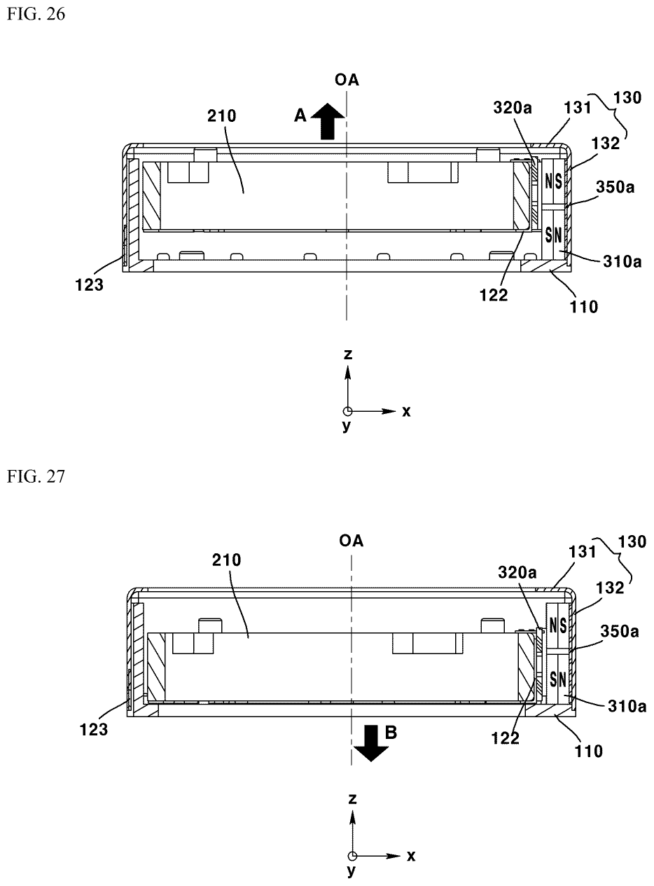

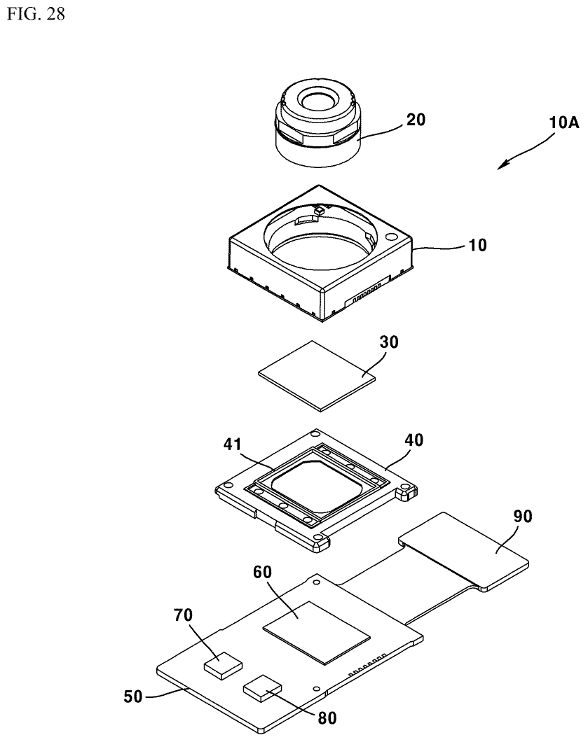

FIGS. 25 to 27 are drawings for explaining an auto focus driving of a lens driving device according to a first modified embodiment and a second modified embodiment. FIG. 25 is a cross-sectional view illustrating a state of a movable unit in an initial state in which no current is applied to a coil. FIG. 26 is a cross-sectional view illustrating a state in which a movable unit moves upward in an optical axis direction when a forward current is applied to a coil. FIG. 27 is a cross-sectional view illustrating a state in which a movable unit moves downward in an optical axis direction when a reverse current is applied to a coil.

As illustrated in FIG. 25, the movable unit 200 may be disposed at a position spaced apart from both the upper plate 131 of the cover 130 and the base 110 in an initial position where no current is applied to the coil 320.

When a forward current is applied to the coil 320, the coil 320 may move upward in an optical axis direction due to the electromagnetic interaction between the coil 320 and the driving magnet 310 (see A of FIG. 26). At this time, the holder 210 may move upward in an optical axis direction together with the coil 320. Furthermore, a lens may move upward in an optical axis direction together with the holder 210. Accordingly, the distance between the lens and the image sensor is changed, and the focus of the image being formed on the image sensor through the lens may be adjusted.

When a reverse current is applied to the coil 320, the coil 320 may move downward in an optical axis direction due to the electromagnetic interaction between the coil 320 and the driving magnet 310 (see B of FIG. 27). At this time, the holder 210 may move downward in an optical axis direction together with the coil 320. Furthermore, the lens may move downward in an optical axis direction together with the holder 210. Accordingly, the distance between the lens and the image sensor may be changed, and the focus of the image being formed on the image sensor through the lens may be adjusted.

Meanwhile, during the movement process of the coil 320, the sensor 330 may move together with the coil 320 to detect the strength of the magnetic field of the driving magnet 310 to detect the amount of movement or position of the lens in an optical axis direction. The amount of movement or position of the lens in an optical axis direction detected by the sensor 330 may be used for auto focus feedback control.

Hereinafter, a camera device according to the present embodiment is described with reference to drawings.

FIG. 28 is an exploded perspective view of a camera device according to the present embodiment.

The camera device 10A may comprise a camera module.

The camera device 10A may comprise a lens module 20. The lens module 20 may comprise at least one lens. The lens may be disposed at a position corresponding to the image sensor 60. The lens module 20 may comprise a lens and a barrel. The lens module 20 may be coupled to a holder 210 of a lens driving device 10. The lens module 20 may be coupled to the holder 210 by screw coupling and/or adhesive. The lens module 20 may move integrally with the holder 210.

The camera device 10A may comprise a filter 30. The filter 30 may block light of a specific frequency band from passing through the lens module 20 from being incident on the image sensor 60. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in the base 110. The filter 30 may comprise an infrared filter. The infrared filter may block light of an infrared region from being incident on the image sensor 60.

The camera device 10A may comprise a sensor base 40. The sensor base 40 may be disposed between the lens driving device 10 and the printed circuit board 50. The sensor base 40 may comprise a protruded portion 41 on which a filter 30 is disposed. An opening may be formed in a portion of the sensor base 40 on which the filter 30 is disposed so that light passing through the filter 30 may be incident on the image sensor 60. The adhesive member may couple or attach the base 110 of the lens driving device 10 to the sensor base 40. The adhesive member may additionally serve to prevent foreign substances from entering the interior of the lens driving device 10. The adhesive member may comprise at least one of an epoxy, a thermosetting adhesive, and an ultraviolet-curable adhesive.

In a modified embodiment, the sensor base 40 may be omitted. In this case, the filter 30 may be coupled to the base 110 of the lens driving device 10. The filter 30 may be coupled to a lower surface of the base 110 of the lens driving device 10. In addition, in a modified embodiment, the sensor holder 40 may be formed to protect only the image sensor 60. That is, the base 110 of the lens driving device 10 may be directly disposed in the printed circuit board 50. At this time, the sensor holder 40 may be disposed inside the base 110. The base 110 may be formed to surround the sensor holder 40. The base 110 may comprise a leg portion, which is an outer side wall being seated in the printed circuit board 50.

The camera device 10A may comprise a printed circuit board (PCB) 50. The printed circuit board 50 may be a substrate or a circuit board. A lens driving device 10 may be disposed in the printed circuit board 50. A sensor base 40 may be disposed between the printed circuit board 50 and the lens driving device 10. The printed circuit board 50 may be electrically connected to the lens driving device 10. An image sensor 60 may be disposed in the printed circuit board 50. Various circuits, elements, control units, and the like may be provided in the printed circuit board 50 to convert an image formed on the image sensor 60 into an electrical signal and transmit it to an external device.

The camera device 10A may comprise an image sensor 60. The image sensor 60 may be configured such that light passing through a lens and a filter 30 is incident to form an image. The image sensor 60 may be mounted on a printed circuit board 50. The image sensor 60 may be electrically connected to the printed circuit board 50. For example, the image sensor 60 may be coupled to the printed circuit board 50 by surface mounting technology (SMT). As another example, the image sensor 60 may be coupled to the printed circuit board 50 by flip chip technology. The image sensor 60 may be disposed such that its optical axis is aligned with that of the lens. That is, the optical axis of the image sensor 60 and the optical axis of the lens may be aligned. The image sensor 60 can convert light being irradiated to the effective image area of the image sensor 60 into an electrical signal. The image sensor 60 can be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to a control unit 80 through a circuit pattern provided in the printed circuit board 50. The motion sensor 70 may output rotational velocity information due to the movement of the camera device 10A. The motion sensor 70 may comprise a two-axis or three-axis gyro sensor or an angular velocity sensor.

The camera device 10A may comprise a control unit 80. The control unit 80 may be disposed in a printed circuit board 50. The control unit 80 may be electrically connected to a coil 320 of a lens driving device 10. The control unit 80 may individually control the direction, intensity, and amplitude of current supplied to the coil 320. The control unit 80 may control the lens driving device 10 to perform an auto-focus function and/or a handshake correction function. Furthermore, the control unit 80 may perform auto-focus feedback control and/or handshake correction feedback control for the lens driving device 10.

The camera device 10A may comprise a connector 90. The connector 90 may be electrically connected to a printed circuit board 50. The connector 90 may comprise a port for being electrically connected to an external device.

Hereinafter, an optical device according to the present embodiment is described with reference to drawings.

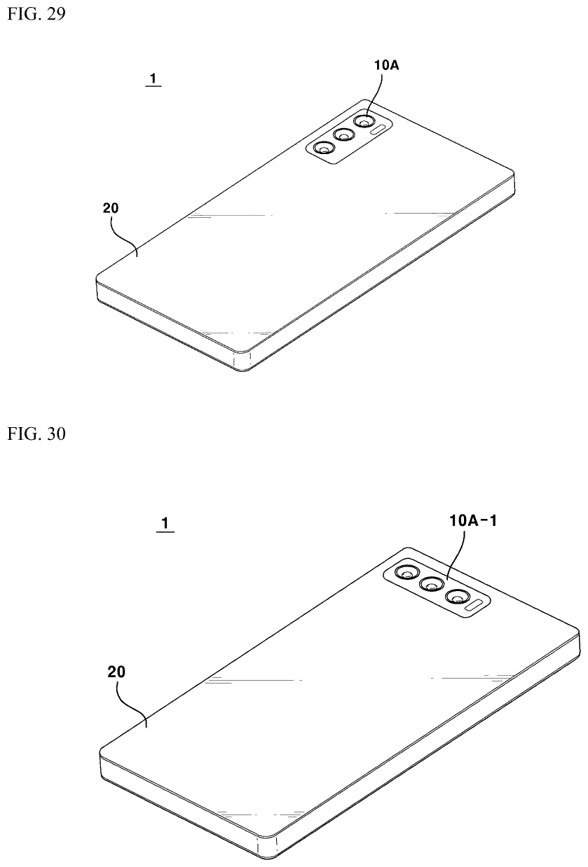

FIG. 29 is a perspective view of an optical device according to the present embodiment; and FIG. 30 is a perspective view of optics according to a modified embodiment.

The optical device 1 may comprise any one or more among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical device 1 may comprise any device for photographing images or pictures.

The optical device 1 may comprise a main body 20. The optical device 1 may comprise a camera device 10A. The camera device 10A may be disposed in the main body 20. The camera device 10A may photograph a subject. The optical device 1 may comprise a display. The display may be disposed in the main body 20. The display may output one or more of an image and a video photographed by the camera device 10A. The display may be disposed on a first surface of the main body 20. The camera device 10A may be disposed on one or more of the first surface of the main body 20 and the second surface opposite to the first surface. As illustrated in FIG. 29, the camera device 10A may have a triple camera disposed in a vertical direction. As illustrated in FIG. 30, the camera device 10A-1 may have a triple camera disposed in a horizontal direction.

In a modified embodiment, the image sensor 60 may be disposed in the holder 210. In this case, the image sensor 60 may be moved in an optical axis direction. When a current is applied to the coil 320, the image sensor 60 may be moved in an optical axis direction through the electromagnetic interaction between the coil 320 and the driving magnet 310. At this time, the lens may be disposed to be fixed. That is, in a modified embodiment, the lens is fixed and the image sensor 60 may be moved in an optical axis direction. Through this, the distance between the lens and the image sensor 60 may be changed. That is, an auto focus (AF) function may be performed.

Although the present embodiment of the present invention has been described with reference to the attached drawings, those skilled in the art will understand that the present invention can be implemented in other specific forms without changing the technical idea or essential characteristics thereof. Therefore, it should be understood that the embodiments described above are exemplary in all respects and not restrictive.

1-10. (canceled)

11. An autofocus driving device comprising:
a fixed unit;
a movable unit disposed in the fixed unit;
a first magnet and a coil configured to move the movable unit in an optical axis direction;
a ball disposed between the fixed unit and the movable unit; and
a second magnet and a yoke having attractive force acting on each other,
wherein the first magnet and the coil are overlapped with each other in a first direction perpendicular to the optical axis direction, and
wherein the ball is disposed between the second magnet and the yoke in the first direction.

12. The autofocus driving device of claim 11, wherein the ball is overlapped with the second magnet in the first direction, and
wherein the ball is overlapped with the yoke in the first direction.

13. The autofocus driving device of claim 11, wherein at least one of the fixed unit and the movable unit comprises a groove disposed with the ball, and
wherein the groove is disposed in the optical axis direction.

14. The autofocus driving device of claim 11, wherein the yoke is not overlapped with the first magnet in the first direction.

15. The autofocus driving device of claim 11, wherein the second magnet is spaced apart from the first magnet.

16. The autofocus driving device of claim 11, wherein in the optical axis direction, a length of the second magnet is greater than a length of the first magnet.

17. The autofocus driving device of claim 11, wherein in a second direction perpendicular to the optical axis direction and the first direction, a length of the second magnet is shorter than a length of the first magnet.

18. The autofocus driving device of claim 11, wherein the second magnet is disposed on the fixed unit, and
wherein the yoke is disposed on the movable unit.

19. The autofocus driving device of claim 11, wherein the first magnet is disposed on the movable unit, and
wherein the coil is disposed on the fixed unit.

20. The autofocus driving device of claim 11, comprising a substrate connecting the movable unit and the fixed unit,
wherein the first magnet is disposed on the fixed unit, and
wherein the coil is disposed on the movable unit and is electrically connected to the substrate.

21. The autofocus driving device of claim 11, wherein the ball comprises a first ball and a second ball,
wherein, when viewed from above, the first ball is disposed at a first corner area of the movable unit, and
wherein, when viewed from above, the second ball is disposed at a second corner area diagonal to the first corner area of the movable unit.

22. The autofocus driving device of claim 21, wherein the fixed unit comprises a first groove contacted with the first ball and a second groove contacted with the second ball,
wherein the movable unit comprises a first groove contacted with the first ball and a second groove contacted with the second ball, and
wherein the second groove of the fixed unit and the second groove of the movable unit are formed in different shapes.

23. The autofocus driving device of claim 21, wherein the second magnet comprises a first unit magnet and a second unit magnet,
wherein the yoke comprises a first yoke and a second yoke,
wherein the first ball is disposed between the first unit magnet and the first yoke,
wherein the second ball is disposed between the second unit magnet and the second yoke, and
wherein the first unit magnet is greater than the second unit magnet.

24. A camera device comprising:
a printed circuit board;
an image sensor disposed on the printed circuit board;
the autofocus driving device of claim 11 disposed on the printed circuit board; and
a lens coupled with the autofocus driving device.

25. An optical device comprising:
a main body;
the camera device of claim 24 disposed on the main body; and
a display disposed on the main body and configured to output at least one or more of an image and a video photographed by the camera device.

26. An autofocus driving device comprising:
a fixed unit;
a movable unit disposed in the fixed unit;
a first magnet and a coil configured to move the movable unit with respect to the fixed unit in an optical axis direction;
a ball contacted with the fixed unit and the movable unit;
a second magnet disposed on any one of the fixed unit and the movable unit; and
a yoke disposed on the other of the fixed unit and the movable unit,
wherein the ball is overlapped with the second magnet and the yoke in a first direction perpendicular to the optical axis direction.

27. The autofocus driving device of claim 26, wherein an attractive force acts between the second magnet and the yoke.

28. The autofocus driving device of claim 26, wherein at least one of the fixed unit and the movable unit comprises a groove disposed with the ball, and
wherein the groove is disposed in the optical axis direction.

29. The autofocus driving device of claim 26, wherein the yoke is not overlapped with the first magnet in the first direction, and
wherein the second magnet is spaced apart from the first magnet.

30. An autofocus driving device comprising:
a fixed unit;
a movable unit disposed in the fixed unit;
a first magnet and a coil configured to move the movable unit with respect to the fixed unit;
a ball configured to guide to move the movable unit with respect to the fixed unit in an optical axis direction;
a second magnet disposed on any one of the fixed unit and the movable unit; and
a yoke disposed on the other of the fixed unit and the movable unit,
wherein the ball is overlapped with the second magnet and the yoke in a first direction perpendicular to the optical axis direction.
